(19) United States
(12) Patent Application Publication
(10) Pub. No.: US 2020/0330914 A1
(43) Pub. Date: Oct. 22, 2020

(54) LIQUID FLOWS IN CYCLONIC PARTICLE SEPARATION CHAMBERS

(71) Applicant: HEWLETT-PACKARD DEVELOPMENT COMPANY, L.P., Spring, TX (US)

(72) Inventors: Sergi CULUBRET, Sant Cugat del Valles (ES); Esteve COMAS, Sant Cugat del Valles (ES); Ignacio ALEJANDRE, Sant Cugat del Valles (ES)

(73) Assignee: HEWLETT-PACKARD DEVELOPMENT COMPANY, L.P., Spring, TX (US)

(21) Appl. No.: 16/087,705

(22) PCT Filed: Apr. 3, 2017
(86) PCT No.: PCT/US2017/025730

§ 371 Date: Sep. 24, 2018

(51) Int. Cl. B01D 45/12; B04C 9/00

(52) U.S. Cl. CPC B01D 45/12; B01D 47/027; B04C 9/00

(57) ABSTRACT

In an example, a filtration apparatus includes a cyclonic particle separation chamber having an inner surface and a liquid source. The liquid source may be to supply liquid to provide a flow of liquid on the inner surface.

### BACKGROUND

Cyclonic particle separation apparatus may be used to separate particles from an air flow. For example, industrial and domestic vacuum cleaners and filters may make use of cyclonic particle separation apparatus.

In examples of such apparatus, air may be drawn into a cylindrical or conical chamber and caused to flow in a spiral. Particles suspended in the air, being heavier, move towards the edge of the chamber. The particles then tend to strike the chamber walls, fall and collect at the bottom of the chamber.

### BRIEF DESCRIPTION OF DRAWINGS

Non-limiting examples will now be described with reference to the accompanying drawings, in which:

FIGS. 1 and 2 are examples of filtration apparatus;

FIG. 3 is an example method for filtering an air flow;

FIG. 4 is an example method for recirculating a liquid; and

FIG. 5 is an example of an additive manufacturing apparatus.

### DETAILED DESCRIPTION

Cyclonic particle separation apparatus are used in vacuum cleaning of surfaces such as floors, textiles and the like and in ‘air scrubbing’ in which dust or other particles may be removed from the air.

In some examples herein, a cyclonic ‘vacuum’ apparatus is used to remove particles suspended in the air removed from a chamber of an additive manufacturing apparatus, which may for example comprise a fabrication chamber, or another chamber of an apparatus for use in additive manufacturing processes, such as a chamber in which objects are post-processed to remove unfused material, or a build material processing (e.g. mixing) chamber, or the like. Additive manufacturing techniques may generate a three-dimensional object on a layer-by-layer basis through the solidification of a build material which may be a powder-like granular material, which may for example be a plastic, ceramic or metal powder. In examples of such techniques, build material is supplied in a layer-wise manner and a solidification method may include heating the layers of build material to cause melting in selected regions.

In some examples, selective solidification is achieved through directional application of energy, for example using a laser or electron beam. In other examples, at least one print agent may be selectively applied to the build material, and may be liquid when applied. For example, a fusing agent having a composition which absorbs energy (also termed a ‘coalescence agent’ or ‘coalescing agent’) may be selectively distributed onto portions of a layer of build material in a pattern derived from data representing a slice of a three-dimensional object to be generated (which may far example be generated from structural design data). When energy (for example, heat) is applied to the layer, the build material coalesces and solidifies to form a slice of the three-dimensional object in accordance with the pattern. In other techniques, other solidification methods, such as chemical solidification methods or binding materials, may be used.

Where powder-like materials are used in object manufacture, some of the powder may become dispersed, for example within the air inside the fabrication chamber, or some other chamber used in additive manufacturing. In some such examples, a vacuum system may be used to extract air from the chamber (for example, to provide cooling within the fabrication chamber, in particular when methods of manufacture which use heating in object generation are used), and the vacuum system may comprise a particle separation apparatus. This particle separation apparatus may be used to remove particles of build material which could otherwise be expelled outside the machine, creating a particle filled atmosphere which may for example be inhaled by machine operators. In some examples, such apparatus may comprise micro filters, cartridge filters, or the like. In examples set out herein, cyclonic particle separation apparatus may be used to separate build material from the extracted air.

Such cyclonic particle separation apparatus may also be used to separate small particles from an air flow in a variety of circumstances. Cyclonic particle separation apparatus is resistant to clogging but may effectively filter a relatively small range of particle sizes from an air flow. To overcome this, it has been proposed to provide multiple cyclonic chambers which may be tailored to individual particle sizes.

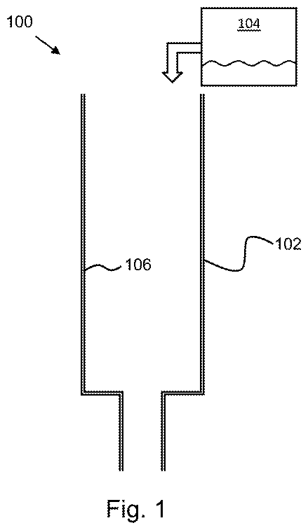

FIG. 1 shows an example of a filtration apparatus 100 comprising a cyclonic particle separation chamber 102 and a liquid source 104.

The cyclonic particle separation chamber 102 has an inner surface 106. In use of the filtration apparatus 100, the liquid source 104 supplies liquid to provide a flow of liquid on the inner surface 106.

Such a flow may trap particles incident thereon, for example when the particles enter the flow, or by adhering to a surface of the liquid under surface tension. Such trapped particles may be borne away by the flow. This prevents the particles from re-entering the air flow, as may be the tendency of, in particular, lighter particles, and therefore a wider range of particles may be efficiently filtered from the air than if a cyclone of equivalent design with a ‘dry’ inner surface was used.

In some examples, the liquid may be water, which is innocuous and readily available, although other liquids may be used.

The liquid source 104 may, in use of the apparatus, supply liquid so as to have at least one intended characteristic. For example, the liquid source 104 may, in use of the apparatus, supply liquid so as to create a substantially continuous flow (rather than a discontinuous flow in which dry patches form), for example a flowing liquid film. The flow may be intended to have a given flow rate and/or thickness, and/or to extend around a given portion of the inner surface.

The liquid source 104 may therefore supply liquid at a rate, and/or in a direction and/or with a dispersion so as to create a liquid flow having any, or any combination of such intended characteristics. This may comprise supplying liquid in a manner which may depend on the type (and/or surface tension) of the liquid used, the steepness and material of the inner surface on which the flow is formed, the ambient temperature and the like.

In practical terms, the filtration apparatus 100 may be for use with a given liquid flowing on an inner surface 106 of a cyclonic particle separation chamber 102 fabricated of particular materials and having an intended orientation, and there may be a predetermined range of operational temperatures. Once such factors are determined, a supply rate to provide an intended liquid flow may be determined, for example analytically using modelling or experimentally. At least one rate of flow may be predetermined and where a plurality of rates of flow are predetermined, a rate may be selected based on any, or any combination of, the local conditions, materials, an intended thickness of the flow on the inner surface 106 or the like.

In some examples herein, the liquid supply rate may be controlled by the size of at least one liquid inlet to the cyclonic particle separation chamber 102. For example, the dimensions of such a liquid inlet may be selected to provide a flow rate and/or fluid dispersion though the inlet which forms the liquid flow on the inner surface 106 so as to have at least one intended characteristic (for example so as to be a continuous liquid flow, to coat the substantially the entire inner surface 106, to be a laminar liquid flow or film, and/or to have an intended thickness, or the like). Liquid may be continuously supplied to such an inlet, which acts as a valve, controlling the amount of liquid entering the cyclonic particle separation chamber 102 such that a flow having the intended characteristic(s) is formed. In some examples, it may be intended to create a flowing liquid film of a predetermined thickness (or a thickness within a predetermined range), and/or a film which exhibits at least substantially laminar or streamline flow (without cross currents, eddies and/or swirls, and/or without substantial turbulence), and a size and/or shape of an aperture or set of apertures to form the inlet(s) may be selected accordingly. However, it may be understood that for a different operating condition (e.g. temperature, air flow rate, or the like), selected liquid, cyclonic particle separation chamber 102, or the like, the dimensions of an inlet which produce such a liquid film may be different. In other examples, a turbulent flow condition may be provided or develop in view of the cyclonic air flow and/or an element of horizontal liquid flow may be introduced by action of the cyclonic air flow.

In some examples, an inlet may be ‘oversized’ such that it could allow liquid therethrough at a higher flow rate than is indicated to form an intended flow on the inner surface, and the rate at which liquid is supplied thereto may be controlled to provide the conditions to form a flow having intended characteristics.

FIG. 2 shows another example of a filtration apparatus 200 and components in common with FIG. 1 are labelled with like numbers. In this example, the cyclonic particle separation chamber 102 comprises a chamber wall 202, and the inner surface 106 is disposed on the chamber wall 202. The chamber wall 202 comprises a liquid inlet slot 204 to allow liquid to enter the cyclonic particle separation chamber 102.

In this example, the liquid source 104 comprises a liquid reservoir 206 to supply a liquid to the liquid inlet slot 204. The reservoir 206 is an annular reservoir and the liquid inlet slot 204 is disposed about the circumference of the chamber wall 202.

In some examples, the inlet slot 204 may extend around substantially the whole circumference such that a liquid film 208 provided over at least substantially the whole of the inner surface 106. This may reduce turbulence in the air flow (for example, the rotational air flow) within the chamber. In some examples, such a liquid film may be provided by a plurality of inlets which are designed to disperse the liquid they dispense over an area, or by providing a close packed array of individual inlets, or in some other way. In still other examples, just parts of the inner surface 106 may have a liquid film 208 thereon.

The filtration apparatus 200 further comprises a liquid supply mechanism 210, in this example comprising a liquid recirculation mechanism 212 comprising a pump 214 and a filter 216. The liquid supply mechanism 210 is controlled by a controller 218.

The liquid supply mechanism 210 is to supply liquid to the reservoir 206 at, at least on average, the rate at which liquid enters the cyclonic particle separation chamber 102. In other words, the reservoir 206 is kept partially full in use of the filtration apparatus 200. The inlet slot 204 may have dimensions (e.g. a width) such that the liquid flow therethrough is capable of providing a liquid film 208 of an intended thickness. The intended thickness of the liquid layer may be selected based on the particle size and/or anticipated concentration within the air. The size of the aperture provided by the inlet slot 204 in this example controls the flow rate therethrough and the liquid supply mechanism 210 may, under the control of the controller 218, match this rate of flow. This may be determined experimentally or analytically or may be measured by a flow meter, for example at the point at which liquid enters the cyclonic particle separation chamber 102 or as the liquid collects at the base thereof. In this example, the inlet slot 204 is of a fixed size but in other examples, the size of the inlet may be variable, for example under the control of the controller 218. In other examples, the controller 218 may control a rate of supply of liquid such that the liquid flow has intended characteristics and/or at least one dimension of an inlet.

The pump 214 and the filter 216 recirculate the liquid which has passed through the cyclonic particle separation chamber 102. It will be appreciated that, as it exits the cyclonic particle separation chamber 102, the liquid may carry particles. While in other examples, a fresh supply of liquid may be provided and/or unfiltered liquid may be recirculated for at least a plurality of cycles, in this example, the liquid is filtered to remove at least a proportion of the particles and recirculated. The filter 216 may for example comprise a sponge or mesh filter to capture the particles. In other examples, the liquid supply mechanism 210 may be a pipe or tube connected to a mains water supply, or any other static liquid supply point which may in some examples supply a fluid under pressure.

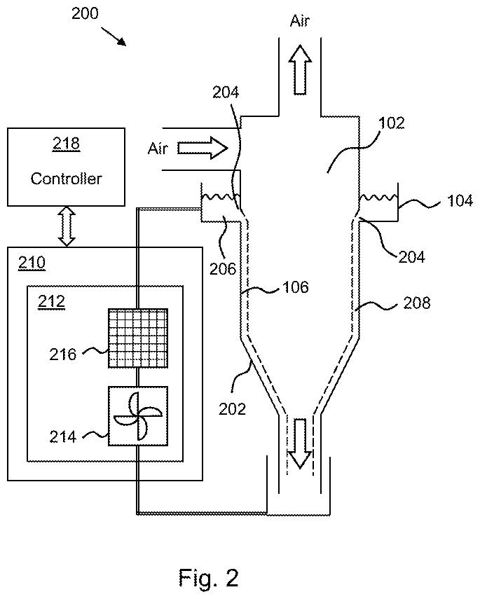

FIG. 3 is an example of a method, which may be a method of filtering and/or separating particles from an air flow. Block 302 comprises creating a flow of liquid on an interior surface of a cyclonic particle separation chamber. This may comprise providing at least one aperture and arranging for liquid to flow therethrough at a flow rate which is suitable for forming a liquid flow on the surface, for example a flowing liquid film. In some examples, the size and/or shape of the apertures may be designed, configured or adjusted to supply liquid to the interior of the surface to create a liquid flow having intended characteristic(s). In some examples, the rate at which liquid is supplied to at least one aperture may be controlled so as to supply liquid to the interior of the surface to create a liquid flow having intended characteristic(s). In some examples, block 302 may comprise supplying liquid to a reservoir which feeds liquid inlet to the cyclonic particle separation chamber with a stable flow of liquid (for example, the flow rate through the inlet may be, at least on average, substantially equal to the rate at which liquid is supplied). In same examples, block 302 comprises creating the flow of liquid on the interior surface of a cyclonic particle so as to have intended characteristic(s) (e.g. one or more of an intended thickness, flow condition (e.g. laminar or turbulent), flow rate, surface coverage or the like).

Block 304 comprises supplying a gas to be filtered to the cyclonic particle separation chamber. In some examples, the gas may be air. In some examples, the gas may be gas from a chamber (e.g. a fabrication chamber) of an additive manufacturing apparatus.

Block 306 comprises generating a helical air flow within the chamber to urge particles in suspension in the gas to become trapped by the liquid flow. For example, this airflow may be created using a fan or the like. As both large and small particles may be, at least at some point in the helical cycle, urged towards the edge of the chamber, this allows such particles to be captured by the liquid before they can become recaptured by the helical air flow and potentially escape the cyclonic particle separation chamber.

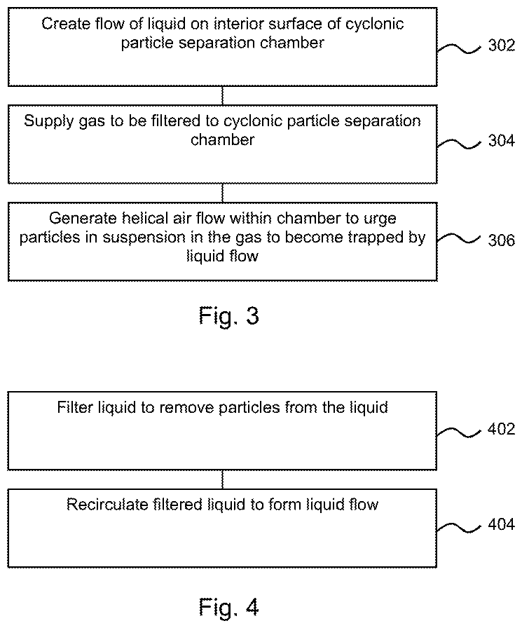

FIG. 4 is another example of a method, which may be a method of recirculating liquid to form the liquid flow of block 302. The method comprises, in block 402, filtering the liquid to remove particles from the liquid. For example, the liquid may be collected at the base of the cyclonic particle separation chamber and passed through a filter. Block 404 comprises recirculating the filtered liquid to form the liquid flow. For example this may be carried out through use of a pump or the like.

In some examples, the methods of FIG. 3 and/or FIG. 4 or parts thereof may be carried out using the filtration apparatus 100, 200 described above.

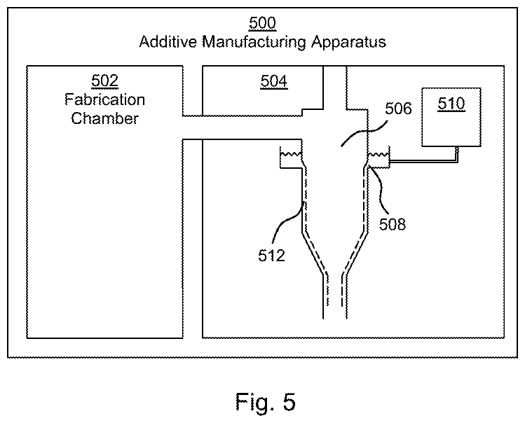

FIG. 5 is an example of an additive manufacturing apparatus 500 comprising a chamber 502 and a cyclonic cooling apparatus 504 to cool the chamber 502 by extracting air therefrom. The cyclonic cooling apparatus 504 comprises a cyclonic particle separation chamber 506 having an annular liquid inlet 508 and a liquid supply mechanism 510. In use of the additive manufacturing apparatus 500, liquid supplied to the annular liquid inlet 508 by the liquid supply mechanism 510 is introduced into the cyclonic particle separation chamber 506 so as to form a flowing liquid film on an interior surface 512 thereof. The additive manufacturing apparatus 500 may be for use in any part of an additive manufacturing process and the chamber 502 may for example comprise a fabrication chamber, a build material processing chamber or a post processing chamber of additive manufacturing apparatus.

The liquid film may trap particles in the air flow and this allows air which is drawn from a chamber 502 of an additive manufacturing apparatus 500 to be efficiently filtered before being exhausted to the atmosphere, thus removing particles which may otherwise enter the atmosphere, for example a room in which the additive manufacturing apparatus 500 is provided.

The cyclonic cooling apparatus 504 may comprise any of the components of the filtration apparatus 100, 200 described above in relation to FIG. 1 and FIG. 2. For example, the liquid supply mechanism 510 may comprise a pump 214 to recirculate liquid which has passed through the cyclonic particle separation chamber and/or a filter 216 to filter such liquid. In some examples, the liquid supply mechanism 510 may be a pipe or tube connected to a mains water supply, or any other static liquid supply point which may supply a fluid under pressure. The annular liquid inlet 508 may allow fluid to enter the cyclonic particle separation chamber 506 from an annular reservoir. The annular liquid inlet 508 may extend around all, substantially all, or part of cyclonic particle separation chamber 506.

The additive manufacturing apparatus 500 may comprise additional components. Far example, further cyclonic coaling apparatus 504 may be provided. In other examples, a print bed may be provided within the apparatus, which in some examples may be lowered as an object is generated such that the layer of an object which is being formed is at a substantially constant height. Further components may comprise a print head, a heat lamp, a build material spreader carriage, powder mixing apparatus or the like. The additive manufacturing apparatus may generate objects in a layer-wise manner from a powder-like build material.

The present disclosure is described with reference to flow charts and block diagrams of the method, devices and systems according to examples of the present disclosure. Although the flow diagrams described above show a specific order of execution, the order of execution may differ from that which is depicted.

Some examples in the present disclosure may utilise machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices (for example, the controller 218) may be implemented by a processor executing machine readable instructions stored in a memory, or a processor operating in accordance with instructions embedded in logic circuitry. The term ‘processor’ is to be interpreted broadly to include a CRU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing.

Further, some teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A filtration apparatus comprising:
a cyclonic particle separation chamber having an inner surface; and
a liquid source to supply liquid to provide a flow of liquid on the inner surface.

2. A filtration apparatus according to claim 1 comprising at least one liquid inlet to the cyclonic particle separation chamber, wherein at least one dimension of the liquid inlet is selected to provide a flow rate though the liquid inlet which forms the flow of liquid on the inner surface so as to have an intended characteristic.

3. A filtration apparatus according to claim 1 wherein:
the cyclonic particle separation chamber comprises a chamber wall, and the inner surface is disposed on the chamber wall, the chamber wall comprising a liquid inlet slot to allow liquid to enter the cyclonic particle separation chamber; and
the liquid source comprises a liquid reservoir to supply a liquid to the liquid inlet slot.

4. A filtration apparatus according to claim 3 wherein the liquid inlet slot is disposed about a circumference of the chamber wall.

5. A filtration apparatus according to claim 3 further comprising a liquid supply mechanism, wherein the liquid supply mechanism is to supply liquid to the liquid reservoir at a rate matched to a rate at which liquid enters the cyclonic particle separation chamber.

6. A filtration apparatus according to claim 1 further comprising a liquid recirculation mechanism comprising a pump.

7. A filtration apparatus according to claim 6 in which the liquid recirculation mechanism further comprises a filter.

8. A filtration apparatus according to claim 1 further comprising a controller, the controller being to control a rate of supply of liquid so as to form the flow of liquid on the inner surface to have an intended characteristic.

9. A method comprising:
creating a flow of liquid on an interior surface of a cyclonic particle separation chamber;
supplying a gas to be filtered to the cyclonic particle separation chamber; and
generating a helical air flow within the cyclonic particle separation chamber to urge particles in suspension in the gas to become trapped by the flow of liquid.

10. A method as claimed in claim 9 further comprising:
supplying liquid to a reservoir which feeds a liquid inlet to the cyclonic particle separation chamber with a stable flow of liquid.

11. A method as claimed in claim 9 further comprising filtering the liquid once it has flowed over the interior surface to remove particles from the liquid.

12. A method as claimed in claim 11 further comprising recirculating the filtered liquid to form the flow of liquid.

13. An additive manufacturing apparatus comprising:
a chamber and a cyclonic cooling apparatus to cool the chamber by extracting air therefrom,
the cyclonic cooling apparatus comprising a cyclonic particle separation chamber having an annular liquid inlet and a liquid supply mechanism, wherein, in use of the apparatus, liquid supplied to the annular liquid inlet by the liquid supply mechanism is introduced into the cyclonic particle separation chamber so as to form a flowing liquid film on an interior surface thereof.

14. An additive manufacturing apparatus according to claim 13 in which the liquid supply mechanism comprises a pump to recirculate liquid which has passed through the cyclonic particle separation chamber.

15. An additive manufacturing apparatus according to claim 14 in which the liquid supply mechanism comprises a filter to filter liquid which has passed through the cyclonic particle separation chamber.
